(19) United States
(12) Patent Application Publication
(10) Pub. No.: US 2013/0279548 A1
(43) Pub. Date: Oct. 24, 2013

(54) DIFFERENTIAL PHASE SHIFT KEYING SYSTEM AND METHOD

(71) Applicants: ABU S. AMANULLAH, San Diego, CA (US); Dumitru Mihai Ionescu, San Diego, CA (US); Lichung Chu, San Diego, CA (US)

(72) Inventors: ABU S. AMANULLAH, San Diego, CA (US); Dumitru Mihai Ionescu, San Diego, CA (US); Lichung Chu, San Diego, CA (US)

(21) Appl. No.: 13/452,743

(22) Filed: Apr. 20, 2012

(51) Int. Cl. H04L 27/20; H04L 27/22; H04W 88/02

(52) U.S. Cl. 375/219; 375/308; 375/330

(57) ABSTRACT

A variation on conventional DPSK binary modulation schemes is provided. One modulation scheme uses 3π/8 differential binary phase shift keying (3π/8-DBPSK) where one symbol is transmitted by phase change of 3π/8 radians and the other symbol is transmitted by phase change of −5π/8 radians. Alternatively, this can be thought of as adding a constant 3π/8 radians to the symbol angle for every bit modulated by conventional DBPSK. In another example, assume a first and second symbols, k−1 and k, respectively, are sent. Where k is the same symbol as k−1, a phase rotation of 3π/8 radians from the k^{th} symbol is used to represent the symbol at k−1; and where the k−1 symbol is the opposite of the k^{th} symbol, its rotation 11π/8 radians from the k^{th} symbol. Other modulation schemes using other phase rotations can be provided.

### TECHNICAL FIELD

The present invention relates generally to wireless communications, and more particularly, some embodiments relate to a differential binary phase shift keying modulation scheme.

### DESCRIPTION OF THE RELATED ART

With the many continued advancements in communications technology, more and more devices are being introduced in both the consumer and commercial sectors with advanced communications capabilities. Additionally, advances in processing power and low-power consumption technologies, as well as advances in data coding techniques have led to the proliferation of wired and wireless communications capabilities on a more widespread basis.

Implantable medical devices now routinely include wireless communications capabilities to allow, for example, wireless transmission of telemetry, such as patient or device data, from the device to a monitoring facility. Likewise command and control information can be wirelessly delivered to the medical device to control the device. This allows one- or two way communications without using wires or leads.

A wireless system for implantable medical device(s) typically includes at least one implanted medical device (IMD) and an external communication device (ECD). The IMD (for example, an ICD, glucose monitor) is typically tasked with monitoring and treating physiological conditions within the human body. The ECD can be a device that is capable of communicating both with the implant and with a second device, such as a remote monitoring station, perhaps using a different wireless system.

The combination of transmit and receive functions defines a transceiver. With many wireless devises, including IMDs, power consumption is an important parameter and system designers often want to keep the power consumption of the implantable device as low as possible. This includes, but is not limited to, the design of the communication link, the RF and analog front-end (AFE) design, component modules (e.g., use of slicer, or a 1-bit ADC, instead of multi-bit ADC) and features, and the efficient use of sleep mode(s) that reduce, as much as possible, the time when at least the radio of the implantable device is active.

In the design of the communication link for IMDs and other wireless devices, one of the factors to be considered is digital baseband processing required for the modulation and demodulation of the chosen digital modulation scheme. Phase-shift keying (PSK) is a digital modulation scheme in which data is communicated by modulating the phase of the carrier signal. With PSK, patterns of binary data are represented using a finite number of phases. Each bit pattern is represented by a symbol that is manifested in its particular phase. At the receiver, the demodulator determines the phase of the received signal and maps it to the symbol it represents, thus recovering the modulated data. To do this, the receiver compares the phase of the received signal to a set of valid modulator phases from a PSK constellation.

An alternative form of PSK is referred to as differential phase-shift keying (DPSK), where the symbols at the modulator's input are mapped to phase shifts, rather than absolute phases. In this system, the demodulator determines the changes in the phase of the received signal. With DPSK, the demodulator compares the phase of a given received symbol with that of the previously received symbol. One of the advantages of DPSK is that the demodulation can typically be done without the estimation of carrier phase at the receiver and this reduces the computational complexity and simplifies the receiver.

In digital communications, a modulator maps information symbols to a finite set of channel alphabet symbols represented as a set of constellation points, also referred as a modulator constellation represented by a constellation diagram. A modulator can be referred to as a constellation mapper. A constellation diagram illustrates the constellation points in a complex plane in which the real and imaginary axes are referred to as the in-phase and in-quadrature phase axes respectively. In conventional DPSK modulation, the modulator uses a PSK constellation of size equal to 2^{b}, where b is the number of (coded) information bits to be mapped to a channel alphabet symbol (or letter) during one use of the modulator (i.e., the size of the finite alphabet at the modulator's input). In variations on DPSK modulation, e.g. π/2-DBPSK, the PSK constellation used by the DPSK modulator has size larger than 2^{b} (i.e., 4>2¹ points in the mentioned case). PSK constellation points are usually chosen with uniform angular spacing around a circle, providing maximum phase-separation between adjacent points. The constellation points are typically positioned on a circle so that they can all be transmitted using the same level of energy.

In conventional differential binary PSK modulation (DBPSK), ‘0’ is transmitted by change of 0 degrees and ‘1’ is transmitted by change of 180 degrees (or π radians) in the transmitted symbol. One variation of DBPSK that is also widely used is π/2-DBPSK where the change in angle is +90 degrees (+π/2 radians) for transmission of ‘0’ and −90 degrees (either −π/2 or 3π/2 radians) for the transmission of ‘1’. An alternative interpretation for π/2-DBPSK is that a constant +π/2 radians is added to the symbol angle for every bit modulated according to conventional DBPSK. This is also the modulation adopted in the IEEE BAN draft standard. FIG. 1 is a diagram illustrating the constellation for a conventional π/2-DBPSK modulation/demodulation system.

### BRIEF SUMMARY OF EMBODIMENTS OF THE INVENTION

According to various embodiments of the invention a variation on conventional binary DPSK modulators is provided. In some embodiments, the scheme uses 3π/8 rotating differential binary phase shift keying (3π/8-DBPSK) where one symbol (e.g., a ‘0’) is transmitted by phase change of 3π/8 radians and the opposite symbol (e.g., a ‘1’) is transmitted by phase change of −5π/8 (or 11π/8) radians.

Alternatively, this can be thought of as adding a constant 3π/8 radians to the phase shift for every bit modulated according to conventional DBPSK.

In another example, assume that first and second symbols, at discrete times k−1 and k, respectively, are output by the modulator. The phase shift of the symbol output at time k relative to that at time k−1 would be a function of the modulating data, either 3π/8 or 11π/8.

According to embodiments of the invention, the proposed variation on rotated DPSK for binary modulation substantially improves BER/PER performance over previously known rotated DPSK when a slicer or 1-bit ADC is employed at the receiver in order to keep implementation complexity low. Additionally, such a 3π/8 rotated differential modulation is more tolerant of a given frequency offset than the π/2-DBPSK modulation. This allows for receiver implementation where the frequency offset need be neither estimated nor compensated during payload demodulation.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating the constellation for a conventional π/2-DBPSK modulation/demodulation system.

FIG. 2 is a diagram illustrating the constellation for a 3π/8-DBPSK modulation/demodulation system in accordance with one embodiment of the systems and methods described herein.

FIG. 3 is a diagram illustrating an example transmit and receive chain that is suitable for use in implementing a DPSK communication system.

FIG. 4 illustrates the performance improvement in BER achieved by using the 3π/8 DBPSK modulation in an uncoded system with floating point (infinite precision ADC) and an uncorrected frequency offset of 30 ppm at the receiver.

FIG. 5 illustrates a comparison of the BER for the two modulation schemes when a slicer/hard limiter is used in an uncoded system.

FIG. 6 illustrates a comparison of the BER for the two modulation schemes when a slicer/hard limiter is used in an uncoded system for another set of uncorrected frequency offset between transmitter and receiver.

FIG. 7 illustrates a comparison of the packet error rate (PER) for a 255 byte packet for the two modulation schemes in which BCH channel coding is employed.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Systems and methods described herein include a variation on conventional binary DPSK modulation schemes. In some embodiments, the scheme uses 3π/8 differential binary phase shift keying (3π/8-DBPSK) where one symbol (e.g., a ‘0’) is transmitted by phase change of 3π/8 radians and the other symbol (e.g., a ‘1’) is transmitted by phase change of −5π/8 radians (or equivalently 11π/8). Alternatively, this can be thought of as having an additional constant rotation of 3π/8 radians to the phase rotation of conventional DBPSK.

In another example, assume that a first and second symbols, at discrete times k−1 and k, respectively, are output by the modulator. The phase shift of the symbol output at time k relative to that at time k−1 would be a function of the modulating data, either 3π/8 or 11π/8.

According to embodiments of the invention, the proposed variation on rotated DPSK for binary modulation improves BER/PER performance in the presence of frequency offset between the transmitter and receiver when one chooses to not compensate for, or correct, the frequency offset in order to keep implementation complexity low. This is possible because such a 3π/8 rotated differential modulation is more tolerant of a given frequency offset than the π/2-DBPSK modulation is. This allows for receiver implementation where the frequency offset need be neither estimated nor compensated during payload demodulation.

A differentially modulated signal can be demodulated both coherently and differentially (in other words, non-coherently). With differential demodulation, the data can be recovered based on the phase change from one symbol to next, and this can be estimated by multiplying consecutive received symbols and making decisions based on the result. The derivation of the exact value of the probability of bit error for differential demodulation is difficult in general. However, for differential binary PSK, the bit error probability can be given by:

$${P}_{b} = \frac{1}{2} {e}^{- {E}_{b} / {N}_{0}}$$

Where E_{b}/N₀ is the signal-to-noise ration (SNR) per bit. This formula assumes that the frequency of the local reference signal is synchronized to the received signal and is valid for both conventional DBPSK and any rotated DBPSK, such as π/2-DBPSK. This is because the additional fixed rotation can be undone before the demodulation processing.

Embodiments described herein utilize a different angle rotation pair for a DBPSK modulation. One scheme uses 3π/8 rotated differential binary phase shift keying (3π/8-DBPSK) where one symbol (e.g., a ‘0’) is transmitted by phase change of 3π/8 radians and the other symbol (e.g., a ‘1’) is transmitted by phase change of −5π/8 radians.

The binary bit stream is mapped to complex symbols by binary differential phase shift keying modulation. The symbols s(k), k=0, 1, . . . , N/log 2M−1 and the bits b(n), n=0, 1, 2, . . . , N−1 are related by means of the following:

$$s ( k ) = s ( k - 1 ) {e}^{j φ k} ; k = 0 , 1 , … , \frac{N}{{log}_{2} M}$$

where

$$s ( - 1 ) = {e}^{j \frac{π}{2}}$$

is the reference for the first symbol applied to the modulator, and the angle φₖ takes values from the following tables.

TABLE 1
π/2 and 3π/8 DBPSK Mapping

| b(n) | φₖ for π/2-DBPSK | φₖ for 3π/8-DBPSK |
|---|---|---|
| 0 | $\frac{π}{2}$ | $\frac{3 π}{8}$ |
| 1 | $\frac{3 π}{2}$ | $\frac{- 5 π}{8}$ |

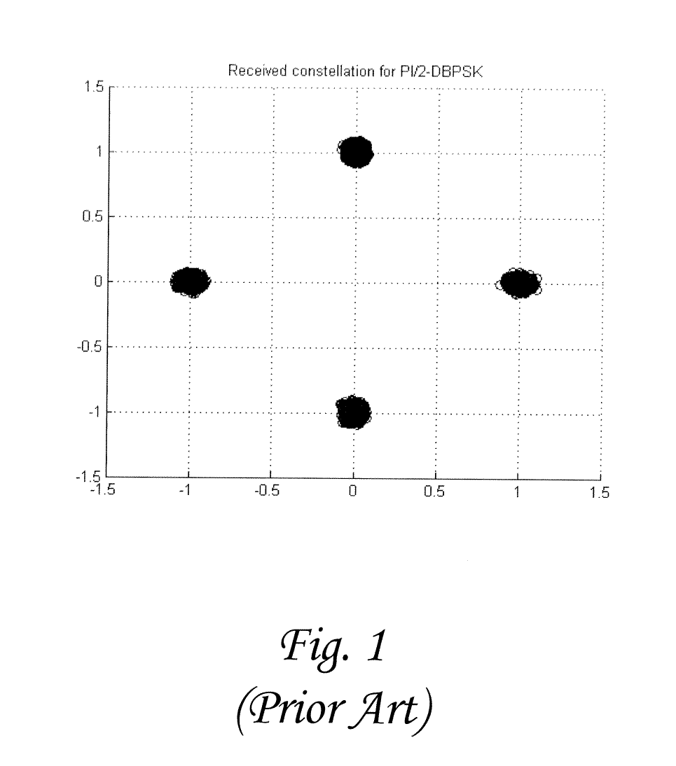

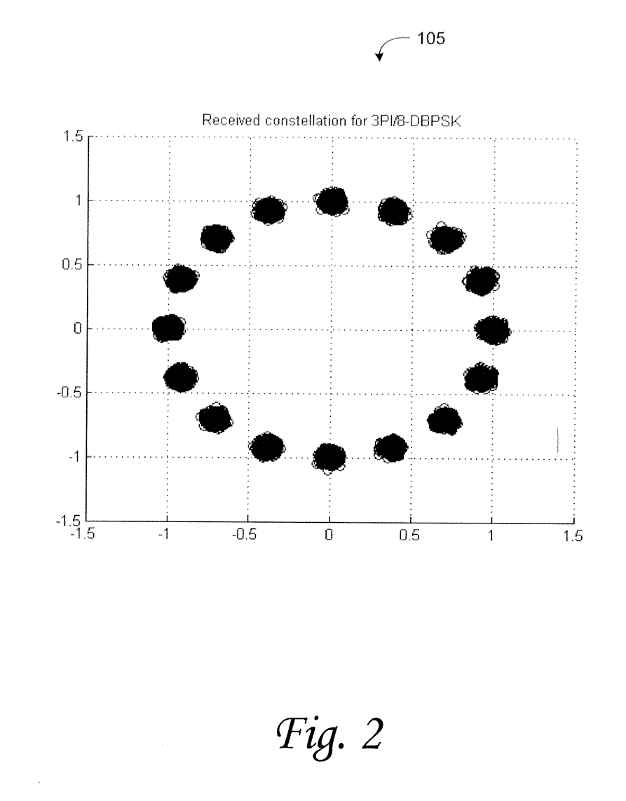

FIG. 1, as noted above, illustrates the received constellation for a conventional π/2 DBPSK modulation scheme. FIG. 2 is a diagram illustrating the received constellation for a 3π/8 DBPSK modulation scheme in accordance with one embodiment of the systems and methods described herein. This constellation 105 includes 16 constellation points for the 3π/8 DBPSK modulation scheme. In contrast, in traditional art a PSK constellation with 16 constellation points, usually referred to as a 16-PSK constellation, is used to transmit a set of four binary (possibly coded) digits, from 0000 to 1111, during each channel use.

The BER performance of (rotated) DBPSK will generally degrade from that given above in paragraph [0026] in the presence of uncorrected frequency offset at the receiver. However, this loss can be reduced by use of a practically advantageous rotated DBPSK, e.g. 3π/8-DBPSK, as described in an embodiment of this invention. This allows for receiver implementation where the frequency offset need be neither estimated nor compensated during payload demodulation consequently reducing computation and power consumption at the receiver. Further improvement in BER/PER is obtained as described in an embodiment of this invention when a slicer is used instead of multi-bit converter. Using a slicer, such as a one-bit ADC, can lead to a lower-power design because the slicer typically consumes less power than a multi-bit ADC. Additionally, an implementation based on a slicer does not require a variable gain amplifier, which in turn results in a relatively simpler receive gain control mechanism that involves only switching the low-noise-amplifier state.

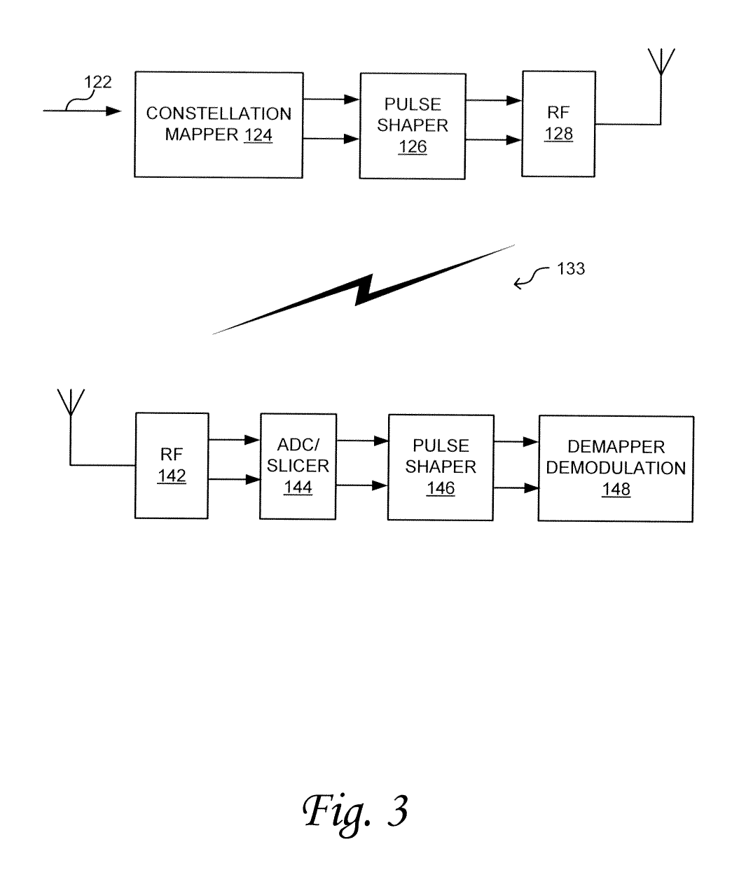

FIG. 3 is a block diagram illustrating relevant portions of a transmit and receive chain for an example phase-modulated communication scheme in accordance with one embodiment of the systems and methods described herein. Referring now to FIG. 3, a binary bit stream 122 is introduced into the system. The binary bit stream 122 may be a series of uncoded bits or it may a series of symbols or encoded bits output from a channel encoder (not illustrated).

The constellation mapper 124 maps segments of the bitstream 122 by assigning them a single complex value in a constellation. Specifically, in some embodiments constellation mapper 124 accepts the input bits 122 and maps the input bits 122, or sets of input bits, to a sample point taken from signal point constellation. For example, in terms of the 3π/8 DBPSK modulation scheme, one symbol (e.g., a ‘0’) is transmitted by phase change of 3π/8 radians and the other symbol (e.g., a ‘1’) is transmitted by phase change of −5π/8 radians.

Constellation mapper 124 generates two outputs that are typically referred to as the in-phase, or I, and in-quadrature, or Q, samples.

The pulse shaper 126 can be included to make the transmitted signal better suited to the communication channel by limiting the effective bandwidth of the transmission. One commonly used pulse shaper is a square root raised cosine filter, although other pulse shapers or low pass filtering techniques can be used.

The in-phase samples are applied via pulse shaper 126 to modulator 128, which multiplies the applied signal by a carrier (e.g., sin ωt). The in-quadrature samples are applied via pulse shaper 126 to modulator 128, which multiplies the applied signal by a second carrier that is orthogonal to the first carrier (e.g., cos ωt). The I and Q output signals of the modulators are added to create the analog signal that is transmitted across wireless channel 133. The transmit DAC/RF Section 128 in this example includes a digital-to-analog converter and a transmitter to transmit the data across the wireless channel 133. With the DAC, the number of bits typically ranges from 4-6 bits.

At the receiver, the RF Section 142 downconverts the received RF signal to an IF or baseband signal. Although not illustrated, filtering can be included to select the desired channel. Also, an additional filtering scheme can be included that also functions as a matched filter to the pulse shaper 126 used in the transmit chain.

An ADC or a slicer/hard limiter 144 may be employed to interface to the digital section. The slicer 144 can be implemented as a 1-bit ADC or a hard limiter. A single slicer 144 evaluates the signal on a real IF signal or there may be one slicer on each of the I and Q channels, which determines if it is a positive or a negative value. In other words, for binary DPSK, the slicer can be configured to output the sign of the received symbol. For example, if the received symbol is positive on inphase signal, slicer maps it to +1.

In some embodiments, the demodulator generates the estimated data bit streams by matching the received symbols to the best-fit symbol, taking into account the modulation scheme employed at the transmitter. In the case of a PSK-modulated signal, for example, the signal phase of the received signal can be compared to all possible phase options as dictated by the modulator. For DPSK, the change in signal phase of the received symbol compared to the phase of the previously received symbol is used to determine the data. In other words, with DPSK, the received symbols are not decoded one-by-one to the constellation points, but instead, phase change Δθₖ=θₖ−θₖ₋₁ between successive symbols is computed and compared to all possible phase changes. The phase selected is the phase that yields the minimum Euclidian distance to the received phase (i.e. has the maximum likelihood).

For example, for a received symbol γₖ in the k^{th} timeslot with a phase φₖ, the symbol can be denoted by γk=\sqrt{Eₛ}e^{jφk}+ηₖ, where nₖ is the additive white Gaussian noise term. The decision for the phase difference between successive symbols, k and k−1, is based on the phase of the complex number:

γₖγ*ₖ₋₁=Eₛe^{j(θ}^{ₖ}^{-θ}^{ₖ₋₁}⁾+\sqrt{Eₛ}e^{jθ}^{ₖ}η*ₖ₋₁+\sqrt{Eₛ}e^{-jθ}^{ₖ}ηₖ+ηₖη*ₖ₋₁

In the absence of noise, the phase of this complex number is θₖ−θₖ₋₁.

In the case of binary DPSK in accordance with the constellation set forth in FIG. 2, the received symbol k will either be rotated 3π/8 or −5π/8 with respect to the previously received symbol k−1.

In the illustrated example, the output symbols are pulse shaped at pulse shaper 146 and sent to Demap and demodulation 148. Demapper 148 essentially performs the inverse of constellation mapper 124 and maps the recovered symbol points into their corresponding bit sets to form the recovered digital data stream.

The above examples describe the DPSK system in terms of a 3π/8-DBPSK constellation mapping. In alternative embodiments, other symbol mapping schemes can be used, such as, for example, 5π/8-DBPSK and 7π/8-DBPSK, or in general (2k+1)π/8-DPSK, where kε{0, 1, 2, 3, 4, 5, 6, 7}. Likewise, schemes such as 3π/16-DBPSK, 5π/16-DBPSK, 7π/16-DBPSK, or other arbitrary angles, can be utilized.

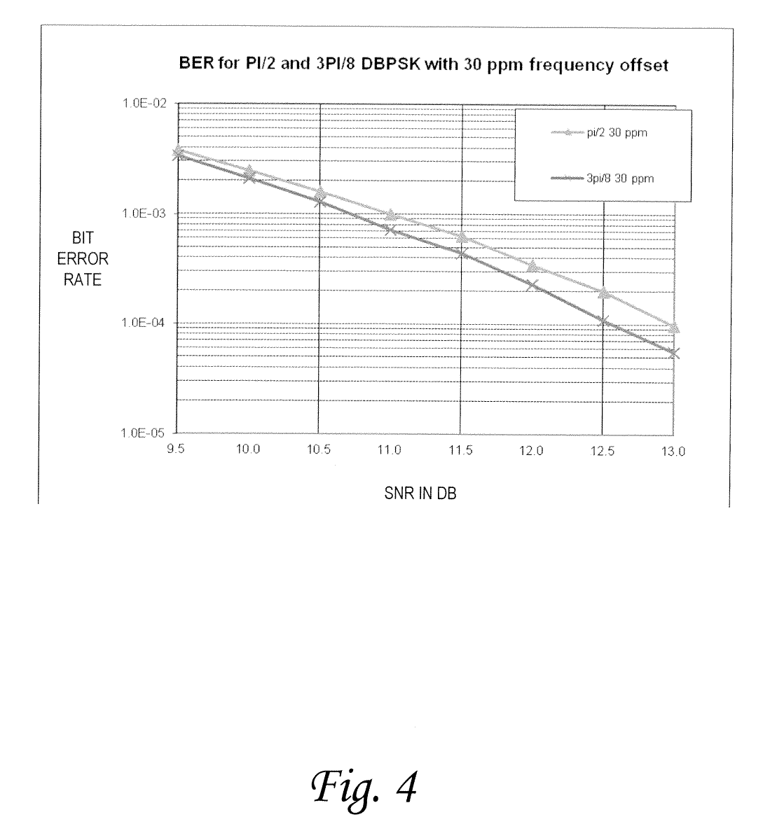

Simulation results comparing the performance of π/2-DBPSK and 3π/8-DBPSK modulations are presented in FIG. 4 through FIG. 7. FIG. 4 illustrates the performance improvement in BER achieved by using the 3π/8 DBPSK modulation scheme in an uncoded system with floating point (infinite precision ADC) and an uncorrected frequency offsets of 30 ppm at the receiver. As can be seen from this graph, the improvement for 30 ppm offset is of the order of 0.3 dB; however, if a slicer/hard limiter is employed, then the performance improvement is much more significant, as is shown in the next section.

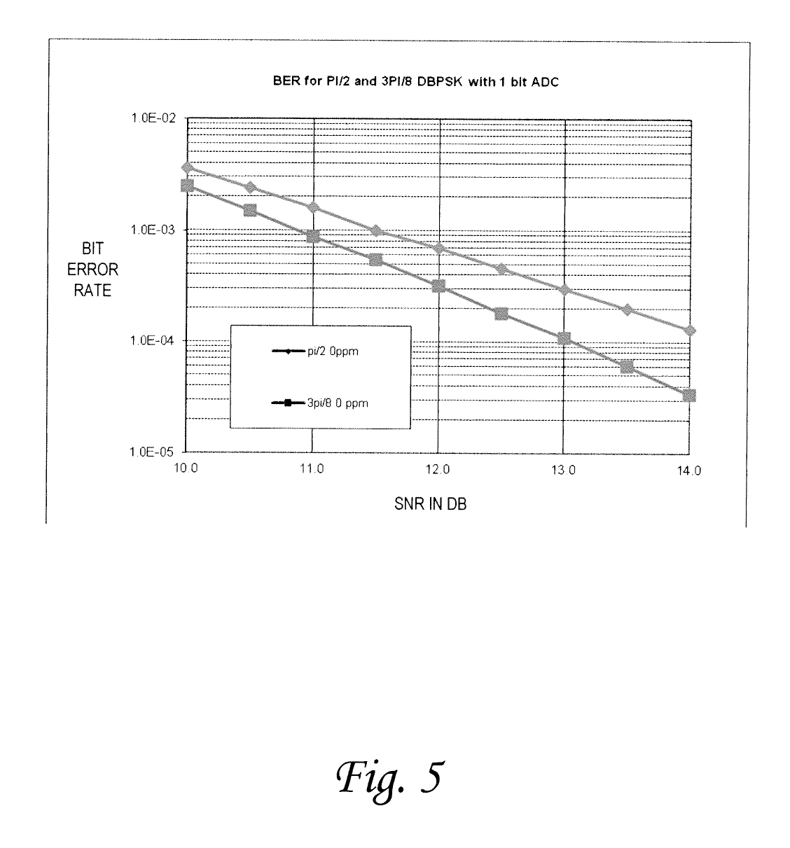

FIG. 5 illustrates a comparison of the BER for the two modulation schemes when a slicer/hard limiter is used in an uncoded system. It can be seen that a SNR improvement of more than 2 dB is obtained at BER=5e-4.

FIG. 5 illustrates a comparison of the BER for the two modulation schemes when a slicer/hard limiter is used in an uncoded system. Results for no frequency offset is presented. It can be seen that a SNR improvement of more than 1 dB is obtained at BER=5e-4 by adopting 3π/8 DBPSK modulation. Other modulations schemes as described above have also demonstrated performance improvements. For example, 5π/8-DBPSK has been investigated and demonstrated improvements over π/2-DPSK when a slicer/hard limiter is employed.

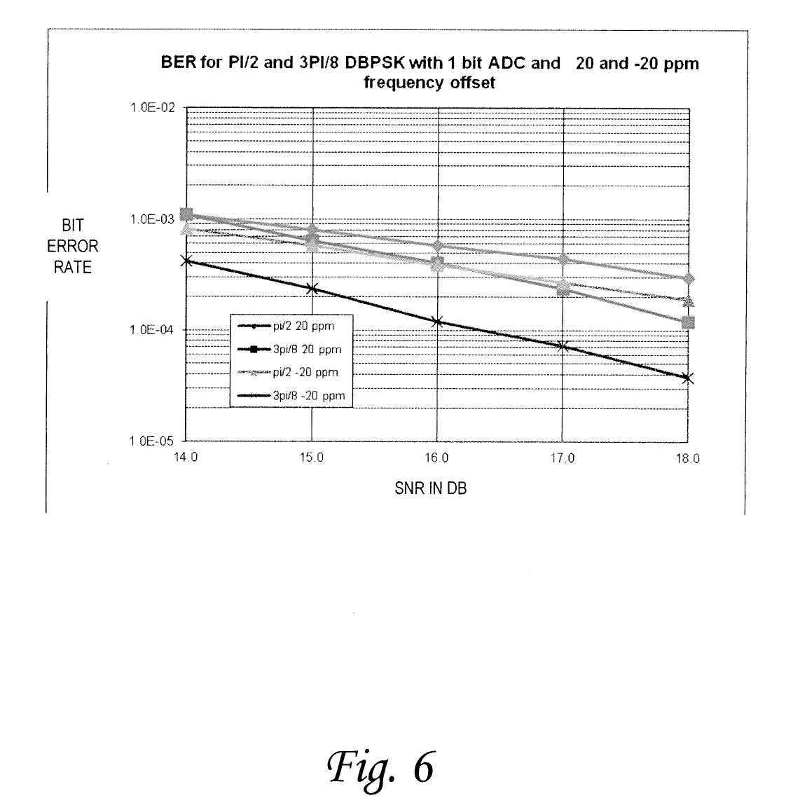

FIG. 6 illustrates simulation results for +/−20 ppm offset in a system. The proposed modulation performs better than PI/2-DBPSK for both cases when the transmitter is leading as well as lagging the receiver.

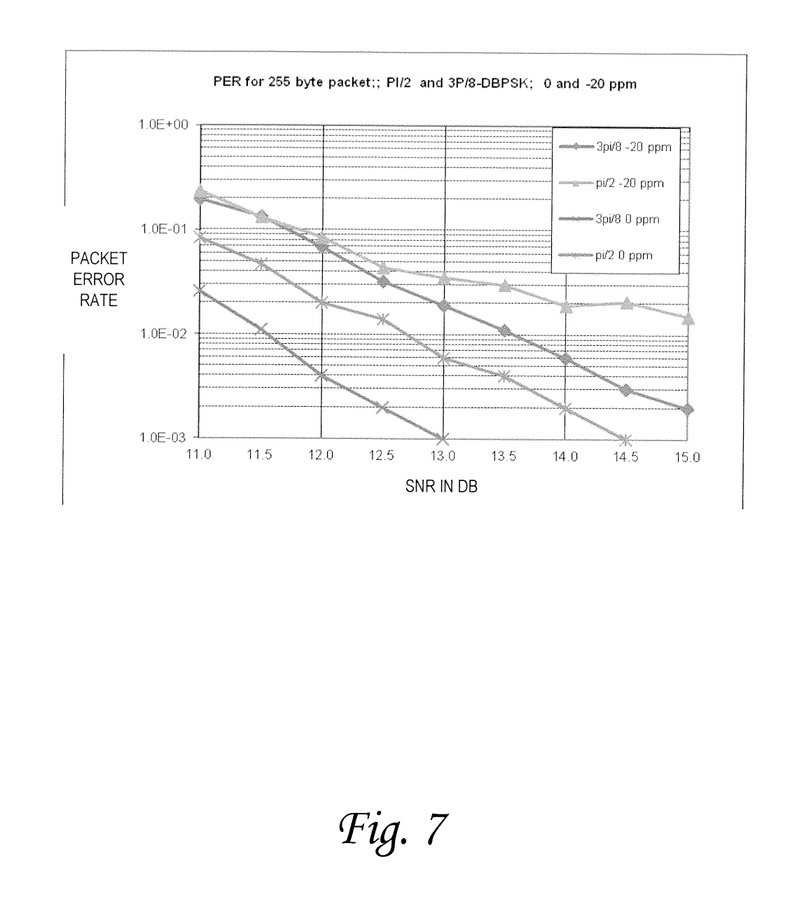

FIG. 7 illustrates simulation results for a system in which BCH channel coding is employed. In this graph, PER for a packet of length 255 bytes is presented. Again the plot shows a significant improvement in SNR of more than 1 dB at PER of 1%.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A DPSK binary modulation scheme for modulating first and second opposite symbols for communication over a wireless communication channel, in which a first symbol is modulated by a phase change of 3π/8 radians, and a second symbol is modulated by a phase change of −5π/8 radians.

2. A wireless communication device comprising at least one of a transmitter and a receiver, wherein the wireless communication device is configured to transmit or receive a wireless signal using a DPSK modulation scheme that modulates a binary data stream in which where one symbol (e.g., a ‘0’) is modulated by a phase change of 3π/8 radians, and the other symbol (e.g., a ‘1’) is modulated by a phase change of −5π/8 radians.

3. The wireless communication device of claim 2, wherein the receiver is implemented without frequency offset correction.

4. The wireless communication device of claim 2, wherein the transmitter comprises a pulse shaper.

5. The wireless communication device of claim 4, wherein the pulse shaper comprises a square root raised sign filter.

6. The wireless communication device of claim 2, wherein the receiver further comprises a slicer.

7. The wireless communication device of claim 2, wherein the receiver is comprises a downconverter, a slicer communicatively coupled to the downconverter and a demodulator communicatively coupled to the slicer and configured to demap the received symbols based on the signs of the symbols.

8. The wireless communication device of claim 7, wherein the receiver further comprises a pulse shaper coupled between the slicer and the demodulator.

9. An implantable medical device comprising a transmitter, wherein the implantable medical device is configured to transmit a wireless signal using a DPSK modulation scheme that modulates a binary data stream in which one of two symbols (e.g., a ‘0’) is modulated by a phase change of 3π/8 radians, and the other of the two symbols (e.g., a ‘1’) is modulated by a phase change of −5π/8 radians.

10. The wireless communication device of claim 9, wherein the transmitter comprises a pulse shaper.

11. The wireless communication device of claim 9, wherein the pulse shaper comprises a square root raised sign filter.

12. The wireless communication device of claim 9, further comprising a receiver configured to receive and demodulate the wireless signal.

13. The wireless communication device of claim 12, wherein the receiver is implemented without frequency offset correction.

14. The wireless communication device of claim 12, wherein the receiver further comprises a slicer.

15. The wireless communication device of claim 12, wherein the receiver is comprises a downconverter, a slicer communicatively coupled to the downconverter and a demodulator communicatively coupled to the slicer and configured to demap the received symbols based on the signs of the symbols.

16. The wireless communication device of claim 15, wherein the receiver further comprises a pulse shaper coupled between the slicer and the demodulator.

17. A wireless transmitter comprising a constellation mapper having an input coupled to receive an input binary data stream, and an output directly or indirectly coupled an RF modulator, wherein the constellation mapper is configured to map bits in the input binary data stream to sample points taken from a constellation, in which a ‘0’ or a ‘1’ input bit is mapped to 3π/8, and an opposite input bit is mapped to −5π/8.

18. A wireless receiver comprising a constellation demapper having an input coupled to receive an input symbol stream modulated by a DPSK modulation scheme and an output, the constellation demapper configured to estimate a phase change of a given received constellation symbol as compared to the constellation symbol received immediately prior to the given received constellation symbol and to use the estimated phase change to output a binary symbol in which a phase difference of 3π/8 results in an output of a symbol at a first state of a 1 or a 0, and a phase difference of −5π/8 results in an output of a symbol at a second state opposite the first state.

19. The wireless receiver of claim 18, further comprising a receiver and a slicer, the slicer having an input communicatively coupled to the receiver and an output communicatively coupled to the constellation demapper, the slicer configured to determine whether the received signal has a positive or a negative value.

20. A DPSK binary modulation scheme for modulating first and second opposite symbols for communication over a wireless communication channel, in which a first symbol is modulated by a phase change of (2k+1)π/8 radians, and a second symbol is modulated by a phase change of (2k+9)π/8 radians, where k is an element of the set {0, 1, 2, 3, 4, 5, 6, 7}.
